(19) United States
(12) Patent Application Publication
(10) Pub. No.: US 2024/0428557 A1
(43) Pub. Date: Dec. 26, 2024

(54) RECORDING METHOD, RECORDING DEVICE, AND PROGRAM

(71) Applicant: FUJIFILM Corporation, Tokyo (JP)

(72) Inventors: Kei YAMAJI, Saitama-shi (JP); Toshiki KOBAYASHI, Saitama-shi (JP); Masaru KOBAYASHI, Saitama-shi (JP)

(73) Assignee: FUJIFILM Corporation, Tokyo (JP)

(21) Appl. No.: 18/823,126

(22) Filed: Sep. 3, 2024

Related U.S. Application Data
(63) Continuation of application No. PCT/JP2022/046895, filed on Dec. 20, 2022.

(30) Foreign Application Priority Data
Mar. 30, 2022 (JP) 2022-056153

(51) Int. Cl. G06V 10/74

(52) U.S. Cl. CPC G06V 10/761; G06V 2201/07

(57) ABSTRACT

There are provided a recording method, a recording device, and a program for efficiently recording accessory information in a frame of moving image data.

There is provided a recording method of recording accessory information in a frame of moving image data including a plurality of frames, the recording method including: a recognition step of recognizing a subject in the frame for each of the frames; a search step of searching for the accessory information that is able to be recorded for the recognized subject among pieces of the accessory information; and a recording step of recording the accessory information in the frame based on a result of the search step, in which, in a case where the number of the frames included in the moving image data is set as a first number and the number of the frames in which the search step is executed is set as a second number, the second number is smaller than the first number.

### CROSS-REFERENCE TO RELATED APPLICATIONS

This application is a Continuation of PCT International Application No. PCT/JP2022/046895 filed on Dec. 20, 2022, which claims priority under 35 U.S.C. § 119 (a) to Japanese Patent Application No. 2022-056153 filed on Mar. 30, 2022. The above applications are hereby expressly incorporated by reference, in their entirety, into the present application.

### BACKGROUND OF THE INVENTION

### 1. Field of the Invention

The present invention relates to a recording method, a recording device, and a program.

### 2. Description of the Related Art

Accessory information related to a subject in a frame may be recorded in the frame (frame image) of moving image data. By recording the accessory information, it is possible to specify a subject in a frame and use the moving image data.

For example, in the invention described in JP1993-309381A (JP-H6-309381A), at least one keyword is assigned to each scene of a moving image based on an operation of a user, and the keyword assigned to each scene is recorded together with the moving image data.

### SUMMARY OF THE INVENTION

On the other hand, in a case where the accessory information such as the keyword is to be recorded for each of a plurality of frames included in the moving image data, a load on the processing is increased, and a recording capacity of the accessory information is increased.

An embodiment of the present invention has been made in view of the above circumstances, and an object of the present invention is to provide a recording method, a recording device, and a program for solving the problem in the related art described above and efficiently recording accessory information in a frame of moving image data.

In order to achieve the above object, according to the present invention, there is provided a recording method of recording accessory information in a frame of moving image data including a plurality of frames, the recording method comprising: a recognition step of recognizing a subject in the frame for each of the frames; a search step of searching for the accessory information that is able to be recorded for the recognized subject among pieces of the accessory information; and a recording step of recording the accessory information in the frame based on a result of the search step, in which, in a case where the number of the frames included in the moving image data is set as a first number and the number of the frames in which the search step is executed is set as a second number, the second number is smaller than the first number.

Further, the search step may not be executed for the frame in which a shake of a subject or an angle of view is detected.

Further, the recording method may further comprise: a first determination step of determining a similarity between a result of the recognition step executed for a first frame among the plurality of frames and a result of the recognition step executed for a second frame different from the first frame among the plurality of frames. In this case, in a case where the similarity determined in the first determination step satisfies a first restriction condition related to an execution of the search step, the execution of the search step for the first frame may be restricted.

Further, in a case where a plurality of subjects are recognized in the recognition step for the first frame and the second frame, in the first determination step, priorities may be set for the plurality of subjects, and the similarity may be determined based on the priorities of the plurality of subjects.

Further, in a case where the number of frames in which the accessory information is recorded in the recording step is set as a third number, the third number may be smaller than the second number.

Further, the recording method may further comprise: a second determination step of determining a similarity between a result of the search step executed for a first frame among the plurality of frames and a result of the search step executed for a second frame different from the first frame among the plurality of frames. In this case, in a case where the similarity determined in the second determination step satisfies a second restriction condition related to an execution of the recording step, the execution of the recording step for the first frame may be restricted.

Further, in the search step for the first frame and the second frame, in a case where the accessory information that is able to be recorded is searched for a plurality of subjects, in the second determination step, priorities may be set to the plurality of subjects, and the similarity may be determined based on the priorities of the plurality of subjects.

Further, the recording method may further comprise a receiving step of receiving an input of a user that is related to a recording instruction of the accessory information. In this case, the recording step may be executed to record the accessory information in an input frame corresponding to the input of the user, among the plurality of frames.

Further, in the recording step for the input frame, information related to the recording instruction may be recorded as the accessory information.

Further, the recording step may be executed to record the accessory information in the input frame and a complementation frame before or after the input frame, among the plurality of frames.

Further, the accessory information may be stored in a data file different from the moving image data.

Further, according to an embodiment of the present invention, there is provided a recording device that records accessory information in a frame of moving image data including a plurality of frames, the recording device comprising a processor. Further, the processor is configured to execute recognition processing of recognizing a subject in the frame for each of the frames, search processing of searching for the accessory information that is able to be recorded for the recognized subject among pieces of the accessory information, and recording processing of recording the accessory information in the frame based on a result of the search processing. In addition, in the embodiment of the present invention, in a case where the number of the frames included in the moving image data is set as a first number and the number of the frames in which the search processing is executed is set as a second number, the second number may be smaller than the first number.

Further, according to an embodiment of the present invention, there is provided a program causing a computer to execute each of the recognition step, the search step, and the recording step included in the recording method according to the embodiment of the present invention described above.

### BRIEF DESCRIPTION OF THE DRAWINGS

FIG. 1 is an explanatory diagram of moving image data.

FIG. 2 is a diagram illustrating accessory information related to a subject in a frame.

FIG. 3 is a diagram illustrating an example of accessory information having a hierarchical structure.

FIG. 4 is a diagram related to a procedure of specifying a position of a subject region having a circular shape.

FIG. 5 is a diagram related to a procedure of recording accessory information in a frame.

FIG. 6 is a diagram illustrating a case where accessory information is recorded in all frames of moving image data.

FIG. 7 is a diagram illustrating a hardware configuration of a recording device according to an embodiment of the present invention.

FIG. 8 is an explanatory diagram illustrating functions of the recording device according to the embodiment of the present invention.

FIG. 9 is a diagram illustrating whether or not a search step is executed for each of a first frame and a second frame similar to each other.

FIG. 10 is an explanatory diagram of an execution rate of a search step.

FIG. 11 is an explanatory diagram of an execution rate of the search step, and is a diagram of a case where a subject in a frame is changed by a change in a scene.

FIG. 12 is an explanatory diagram of complementation of the accessory information.

FIG. 13 is an explanatory diagram of an execution rate of the search step, and is a diagram in a case where a user inputs a recording instruction of the accessory information.

FIG. 14 is a diagram illustrating whether or not a recording step is executed for each of the first frame and the second frame having similar results in the search step.

FIG. 15 is an explanatory diagram of an execution rate of a recording step.

FIG. 16 is an explanatory diagram of an execution rate of a recording step, and is a diagram in a case where a user inputs a recording instruction of the accessory information.

FIG. 17A is a diagram illustrating a recording flow according to the embodiment of the present invention (part 1).

FIG. 17B is a diagram illustrating a recording flow according to the embodiment of the present invention (part 2).

FIG. 18 is a diagram illustrating a variation in execution rate of each of the search step and the recording step.

FIG. 19 is a diagram illustrating a modification example related to the execution rate of the search step.

FIG. 20 is a diagram illustrating an example in which accessory information is stored in a data file different from moving image data.

### DESCRIPTION OF THE PREFERRED EMBODIMENTS

Hereinafter, a specific embodiment of the present invention will be described. It should be noted that the embodiment to be described below is merely an example for facilitating understanding of the present invention and does not limit the present invention. The present invention may be modified or improved from the embodiment to be described below without departing from the spirit of the present invention. In addition, the present invention includes equivalents thereof.

In the present specification, the concept of “device” includes a single device that exerts a specific function, and includes a combination of a plurality of devices that are distributed and present independently of each other and exert a specific function in cooperation (coordination) with each other.

In addition, in the present specification, the “person” means a subject that performs a specific action, and the concept of the “person” includes an individual, a corporation such as a group or a company, and an organization. In addition, a computer and a device constituting artificial intelligence (AI) may be included in the “person”. The artificial intelligence implements intellectual functions such as reasoning, prediction, and determination using hardware resources and software resources. The artificial intelligence may use any algorithm such as, for example, an expert system, case-based reasoning (CBR), a Bayesian network, or a subsumption architecture.

### EMBODIMENT OF PRESENT INVENTION

An embodiment of the present invention relates to a recording method, a recording device, and a program that record accessory information in a frame of moving image data.

### Moving Image Data and Frame

The moving image data is created by a well-known moving image capturing device (hereinafter, referred to as an image capturing device), such as a video camera or a digital camera. The image capturing device generates analog image data (RAW image data) by capturing an image of a subject within an angle of view under preset exposure conditions at a constant frame rate (the number of frame images captured in a unit time). Thereafter, the image capturing device creates a frame (specifically, data of a frame image) by performing correction process, such as γ correction, on digital image data converted from the analog image data.

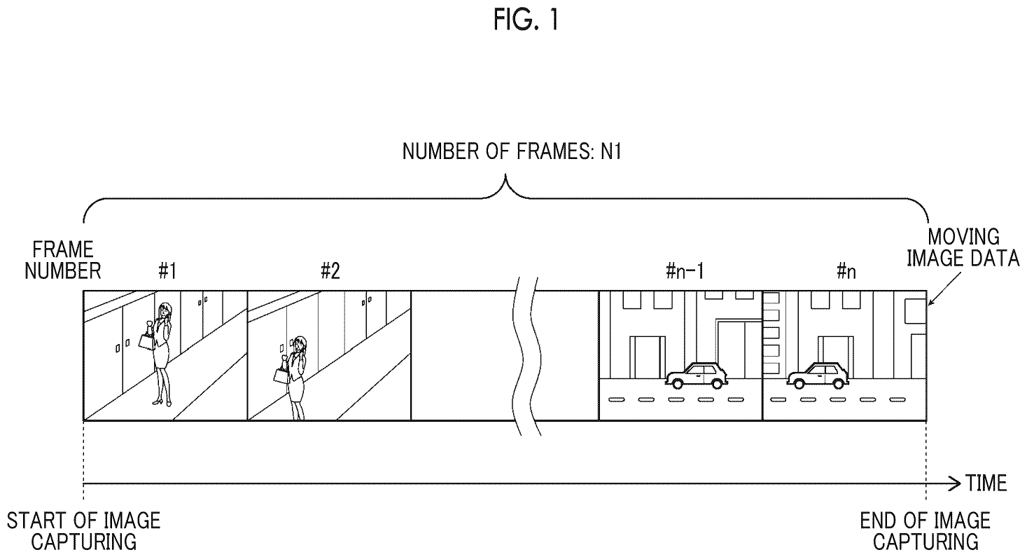

In addition, in a case where the image capturing device records the data of the frame image at a certain rate (interval), as illustrated in FIG. 1, moving image data including a plurality of frames is created. Note that, in the following description, the number of frames included in the moving image data is referred to as a first number N1.

One or more subjects are included in each frame of the moving image data, that is, one or more subjects are present within the angle of view of each frame. The subject is a person, an object, a background, and the like that are present within the angle of view. In addition, in the present specification, the subject is interpreted in a broad sense, and is not limited to a specific object, and may include a landscape (scenery), a scene such as dawn and night, an event such as a trip and a wedding ceremony, a theme such as cooking and a hobby, and a pattern or a design.

The moving image data has a file format corresponding to the data structure. The file format includes a file format corresponding to a codec (compression technology) of the moving image data and version information. Examples of the file format include moving picture experts group (MPEG)-4, H.264, motion JPEG (MJPEG), high efficiency image file format (HEIF), audio video interleave (AVI), QuickTime file format (MOV), Windows media video (WMV), and flash video (FLV). MJPEG is a file format in which frame images included in a moving image are images in a joint photographic experts group (JPEG) format.

The file format is reflected in the data structure of each frame. In the embodiment of the present invention, the head data in the data structure of each frame starts from a marker segment of a start of image (SOI) or a bitmap file header which is header information. The information includes, for example, information indicating a frame number (consecutive number assigned in order from a frame at a start of image capturing).

In addition, the data structure of each frame includes data of the frame image. The data of the frame image indicates a resolution of the frame image recorded at the angle of view when performing image capturing, a gradation value of two colors of black and white or three colors of red, green, and blue (RGB) which are defined for each pixel, and the like. The angle of view is a range for data processing when the image is displayed or drawn, and the range is defined in a two-dimensional coordinate space having two axes orthogonal to each other as coordinate axes.

In addition, the data structure of each frame may include a region in which the accessory information can be recorded (written). The accessory information is tag information related to each frame and a subject in each frame.

In a case where the moving image file format is, for example, HEIF, accessory information in an exchangeable image file format (Exif) corresponding to cach frame, specifically, information related to an imaging date and time, an imaging location, imaging conditions, and the like can be stored. The imaging condition includes a type of the image capturing device that is used, an exposure condition such as an ISO sensitivity, an f-number, and a shutter speed, a focusing position (for example, a focus point in a case of autofocus), and a content of image processing. The content of the image processing includes a name and a feature of the image processing that is executed on the image data of the frame, a device that executes the image processing, a region in the angle of view in which the image processing is executed, and the like.

### Accessory Information

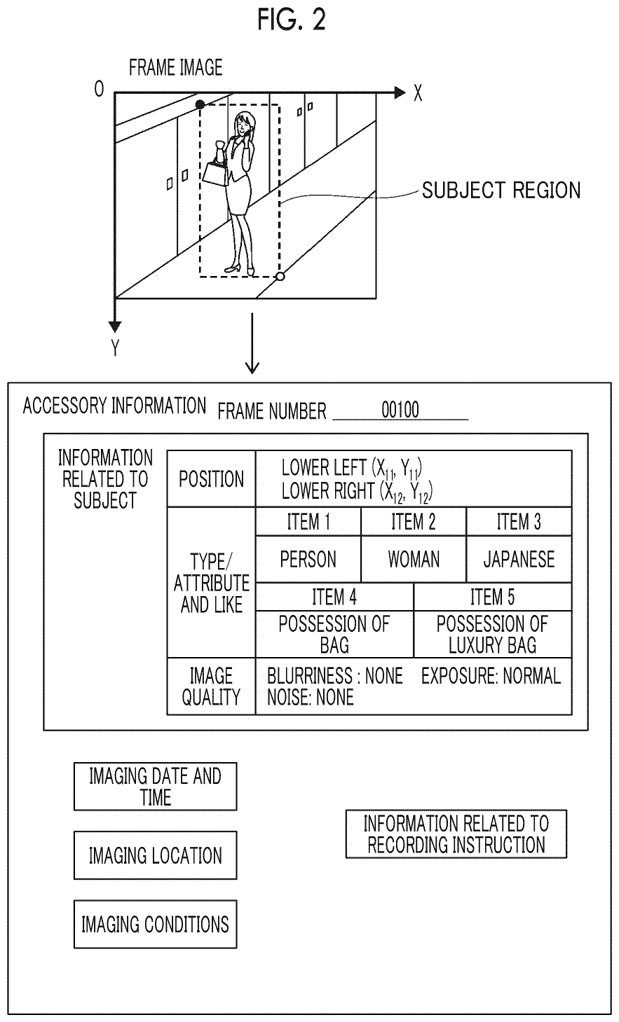

In each frame of the moving image data, a box region in which accessory information can be recorded is provided, and accessory information related to a subject in the frame can be recorded. Specifically, an item corresponding to the subject can be recorded as the accessory information related to the subject. In a case where the subject is classified into each viewpoint, items include an article and a category corresponding to the subject, and include, in an easy-to-understand manner, phrases (words) representing a type, a state, a property, a structure, an attribute, and other features of the subject. For example, in the case illustrated in FIG. 2, “person”, “woman”, “Japanese”, “possession of bag”, and “possession of luxury bag” correspond to the items.

In addition, the accessory information including two or more items may be added to one subject, or the accessory information including a plurality of items having different degrees of abstraction may be added to one subject. In addition, as the number of items of the accessory information added to one subject increases, or as the accessory information is more specific (detailed), the accuracy of the items of the accessory information for the subject becomes higher. Here, the accuracy is a concept representing a degree of detail (fineness) of the content of the subject that is described by the accessory information.

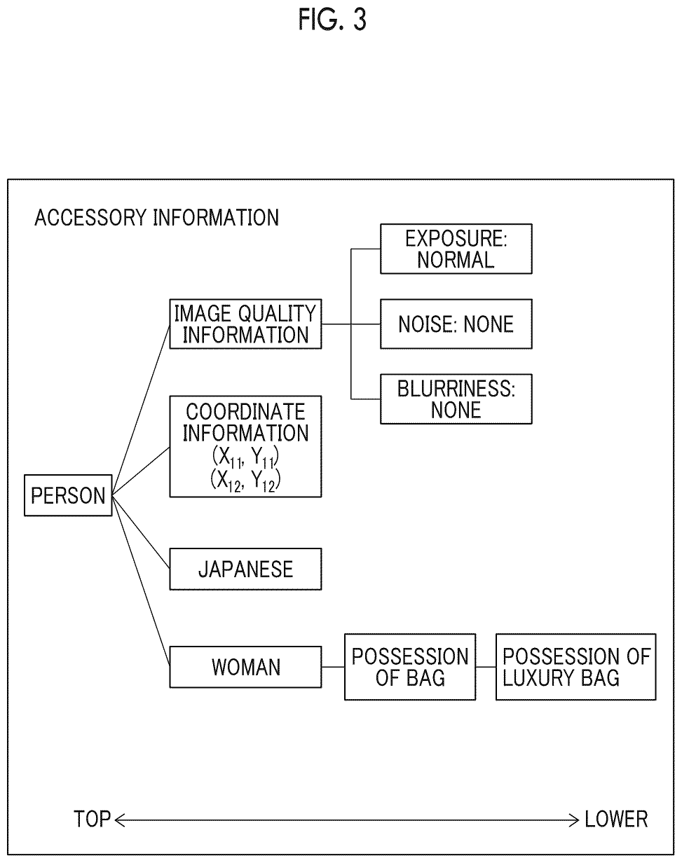

In addition, the accessory information including an item having higher accuracy than the item may be added to the subject to which the accessory information including the item is added. For example, in the case illustrated in FIG. 3, for example, the accessory information including an item of “woman” with higher accuracy is added to the subject to which the accessory information including an item of “person” is added. In addition, the accessory information including an item of “possession of luxury bag” with higher accuracy is added to the subject to which the accessory information including an item of “possession of bag” is added.
Note that, preferably, the accessory information is defined for each hierarchy as illustrated in FIG. 3.

In addition, the item of the subject may include an item that cannot be identified from the appearance of the subject, for example, the presence or absence of an abnormality such as a disease in a crop, or a quality such as a sugar content of a fruit. The item that cannot be identified from the appearance as described above can be determined from a feature amount of the subject in the image data. Specifically, a correspondence relationship between a feature amount of the subject and an attribute of the subject is trained in advance, and the attribute of the subject can be determined (estimated) from the feature amount of the subject in the image based on the correspondence relationship.

Note that the feature amount of the subject includes, for example, a resolution, a data amount, a degree of blurriness, and a degree of a shake of the subject in the frame, a size ratio of the frame to an angle of view, a position in the angle of view, a tint, or a combination of a plurality of these attributes. The feature amount can be calculated by applying a known image analysis technique and analyzing a subject region in an angle of view. In addition, the feature amount may be a value output by inputting a frame (image) to a mathematical model constructed by machine learning, and may be, for example, a one-dimensional vector value or multi-dimensional vector value. In addition, at least, any value that is uniquely output when one image is input can be used as a feature amount.

Further, in the box region, the accessory information indicating a position (coordinate position) of the subject in the angle of view and accessory information indicating a distance (depth) to the subject in a depth direction may be recorded. As illustrated in FIG. 2, the coordinates of the subject are coordinates of a point present on an edge of a region (hereinafter, a subject region) that surrounds a part or the whole of the subject in a two-dimensional coordinate space that defines the angle of view of the frame. A shape of the subject region is not particularly limited, and may be, for example, a substantially circular shape or a rectangular shape. The subject region may be extracted in a case where a user designates a certain range within the angle of view, or may be automatically extracted by using a known subject detection algorithm or the like.

In a case where the subject region is a rectangular region indicated by a broken line in FIG. 2, the position of the subject is specified by coordinates of two intersections (points indicated by a white circle and a black circle in FIG. 2) located at both ends of a diagonal line at an edge of the subject region. In this way, the position of the subject in the angle of view can be accurately specified by the coordinates of a plurality of points.

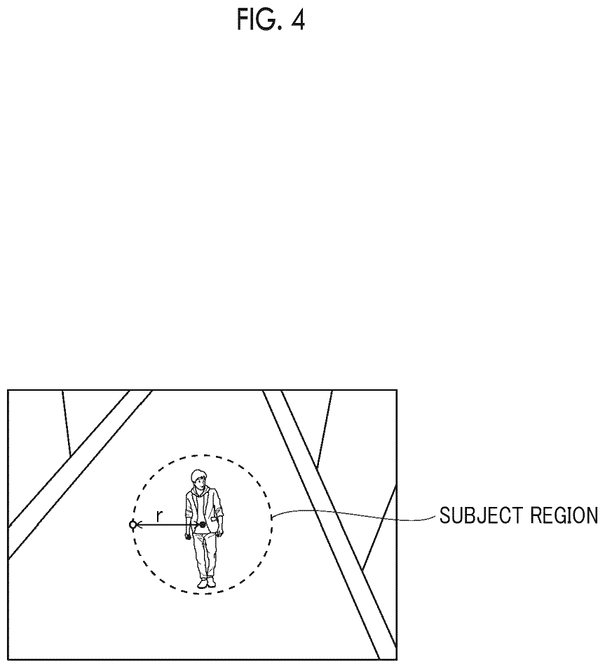

In addition, the subject region may be a region specified by the coordinates of a base point in the subject region and a distance from the base point. For example, in a case where the subject region has a circular shape as illustrated in FIG. 4, the subject region is specified by coordinates of a center (base point) of the subject region and a distance from the base point to an edge of the subject region (that is, a radius r). In this case, the coordinates of the center which is the base point and the radius which is the distance from the base point are the position information of the subject region. By using the base point in the subject region and the distance from the base point in this way, it is possible to accurately represent the position of the subject.
Note that the position of the subject region having a rectangular shape may be represented by the coordinates of the center of the region and the distance from the center in cach coordinate axis direction.

Further, as illustrated in FIG. 2, the accessory information indicating the image quality of the subject may be recorded in the box region. The image quality is the image quality of the subject that is indicated by the data of the frame image, and includes, for example, a sense of resolution, noise, brightness, and the like of the subject. The sense of resolution includes the presence or absence of blurriness or a shake, a degree of blurriness or a shake, resolution, a grade or a rank corresponding to these factors, and the like. The noise includes an S/N ratio, the presence or absence of white noise, a grade or a rank corresponding to these factors, and the like. The brightness includes a brightness value, a score indicating the brightness, a grade or a rank corresponding to these factors, and the like. In addition, the brightness may include the presence or absence of an exposure abnormality, such as whiteout or blackout (whether or not the brightness exceeds a range that can be expressed by a gradation value). In addition, the information indicating the image quality may include an evaluation result (sensory evaluation result) in a case where the sense of resolution, the noise, the brightness, and the like are evaluated based on the human sense.

Further, as illustrated in FIG. 2, the accessory information related to a recording instruction may be recorded in the box region of the frame in a case where a user input related to the recording instruction of the accessory information is performed. The information related to the recording instruction is information specifying that the recording instruction is given, or an identification code (sign information) indicating that the recording instruction is given in the frame. The recording instruction of the accessory information will be described later.

The moving image data in which the accessory information described above is recorded in the frame is used for various applications, and can be used, for example, for the purpose of creating training data for machine learning. Specifically, since the subject in the frame can be specified from the accessory information (specifically, the item of the accessory information), the moving image data is annotated (sorted) based on the accessory information recorded in the frame. The annotated moving image data and the data of the frame image of the annotated moving image data are used to create training data, and machine learning is performed by collecting training data required for machine learning.

### Basic Flow for Recording Accessory Information

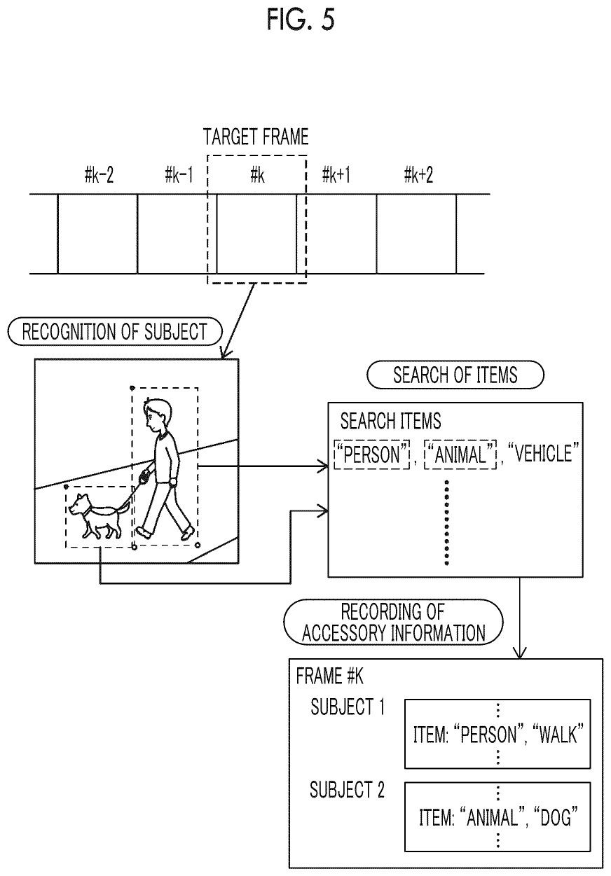

Hereinafter, a basic flow of recording the accessory information in the frame of the moving image data will be described with reference to FIG. 5. Note that, in the following description, among the plurality of frames included in the moving image data, a frame in which the accessory information is recorded (in particular, a frame in which the accessory information related to the subject is recorded) is also referred to as a “target frame”.

In a case where the accessory information is recorded in the target frame, first, as illustrated in FIG. 5, the subject in the target frame is recognized. Specifically, a subject region within the angle of view of the target frame is extracted, and a subject in the extracted region is recognized. Note that, in a case where a plurality of subject regions are extracted in the target frame, the same number of subjects as the number of extracted regions are recognized.

Next, the accessory information that can be recorded for the recognized subject is searched for based on search items. The search items are a plurality of items (item groups) that are set as candidates of the accessory information. For example, in a case where the subject is a person, an item of “person” is searched for from the search items.

In addition, the search items include a plurality of items in which the accuracy (specifically, fineness) for a certain viewpoint is gradually changed. For example, the search items include an item of “person”, and further include items representing gender, age, nationality, occupation, and the like as more detailed items related to “person”. Further, an item corresponding to the recognized subject is searched for from the search items as the accessory information that can be recorded for the subject. In this case, as the number of items to be searched for increases, or as the items to be searched for are more specific (detailed), the accuracy of the search is higher.

In addition, the accuracy of the search item, that is, the number of items included in the search items and fineness of the items included in the search items are variable, and can be changed after being set once. For example, after the accuracy of the search item is set according to the subject (first subject) in a certain frame, the accuracy of the search item for the subject (second subject) in another frame can be changed according to the second subject.

The accuracy of the search item may be set to be high according to the subject in the preceding frame. For example, whether or not a subject (first subject) in a certain frame is a person may be searched for, and a search item having higher accuracy, such as gender, nationality, and age, may be set for the subject (the same subject as the first subject) in a subsequent frame.

Note that the method of searching for the accessory information that can be recorded for the subject is not particularly limited. For example, a type, a property, a state, and the like of the subject may be estimated from the feature amount of the subject, and an item that matches or corresponds to the estimation result may be found from the search items. In addition, in a case where a plurality of subjects are recognized in the target frame, the accessory information that can be recorded for at least some of the plurality of subjects may be searched for from the search items.

Next, the searched items (that is, some of the search items) are recorded in the target frame as the accessory information based on the search result described above. The recording of the accessory information in the target frame is, for example, writing the accessory information in the box region (specifically, a box region conforming to JUMBF) provided in the image data of the target frame. Note that, in a case where the item corresponding to the subject in the target frame is not present in the search items, the accessory information indicating “no corresponding item” may be recorded in the target frame.
In addition, in a case where a plurality of subjects are recognized in the target frame, as illustrated in FIG. 5, the accessory information (item) is searched for each subject, and the searched accessory information (item) is recorded in the target frame in association with the corresponding one subject. Note that the search of the accessory information (item) may not be executed for all of the plurality of subjects in the frame.

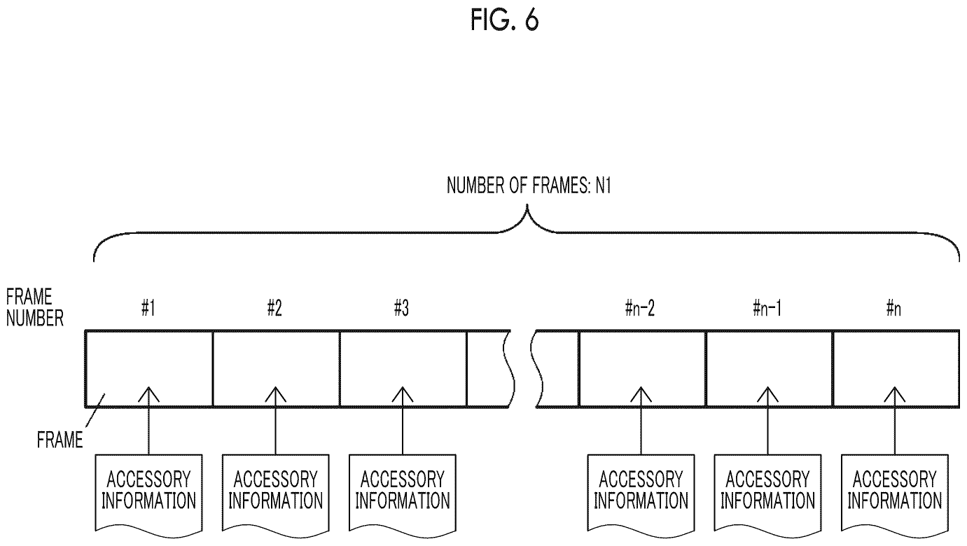

Meanwhile, in a case where the accessory information is recorded in the frame of the moving image data by the above-described procedure, it is preferable to efficiently record the accessory information. On the other hand, as illustrated in FIG. 6, in a case where the accessory information is to be recorded in each of the frames included in the moving image data, a load on the processing described above is increased. In addition, an amount of the accessory information to be recorded is enormous, and a recording capacity of the moving image data is increased. As a result, a recording time of the moving image data (in other words, the first number N1 of frames included in the moving image data) is reduced.

On the other hand, in the moving image data, there is a case where the subjects are the same or similar to each other (for example, in a case where the common subject is captured) between the preceding and subsequent frames. In that case, the accessory information that can be recorded for the subject in the frame is common between the frames, and the search results of the accessory information (items) may be similar (overlap) between the preceding and subsequent frames.

In the embodiment of the present invention, in order to efficiently record the accessory information in the frame of the moving image data, a recording device and a recording method to be described below are used. In the following description, a configuration of a recording device according to the embodiment of the present invention and a flow of a recording method according to the embodiment of the present invention will be described.

### Configuration of Recording Device According to Embodiment of Present Invention

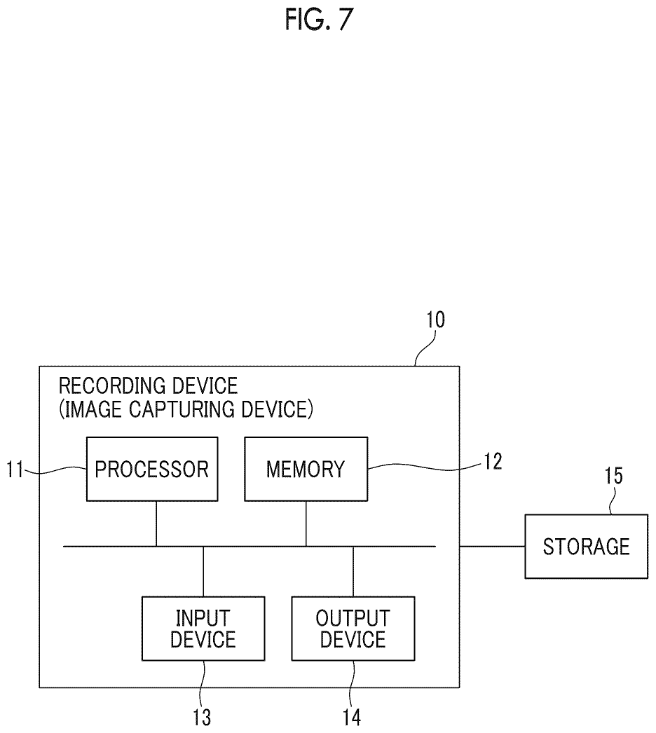

As illustrated in FIG. 7, a recording device (hereinafter, a recording device 10) according to the embodiment of the present invention is a computer comprising a processor 11 and a memory 12. The processor 11 is configured by using, for example, a central processing unit (CPU), a graphics processing unit (GPU), a digital signal processor (DSP), or a tensor processing unit (TPU). The memory 12 is configured by using, for example, a semiconductor memory, such as a read only memory (ROM) and a random access memory (RAM).

In addition, the recording device 10 comprises an input device 13 that receives a user operation, such as a touch panel and a cursor button, and an output device 14, such as a display and a speaker. The input device 13 may include a device that receives a voice input of the user. In this case, the recording device 10 may recognize the voice of the user, analyze the voice by morphological analysis or the like, and acquire the analysis result as the input information.

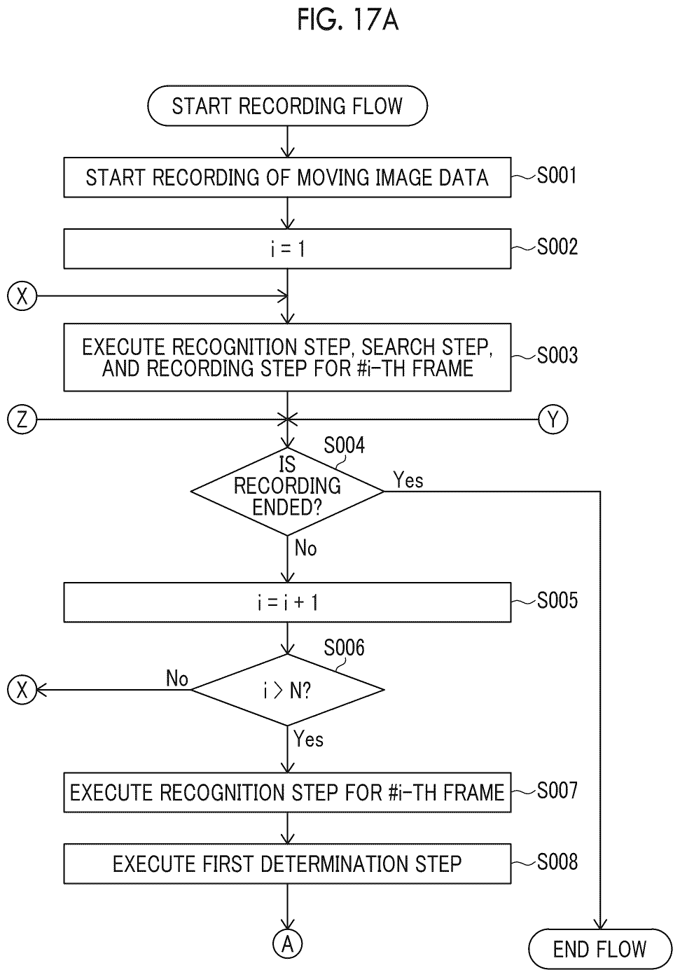

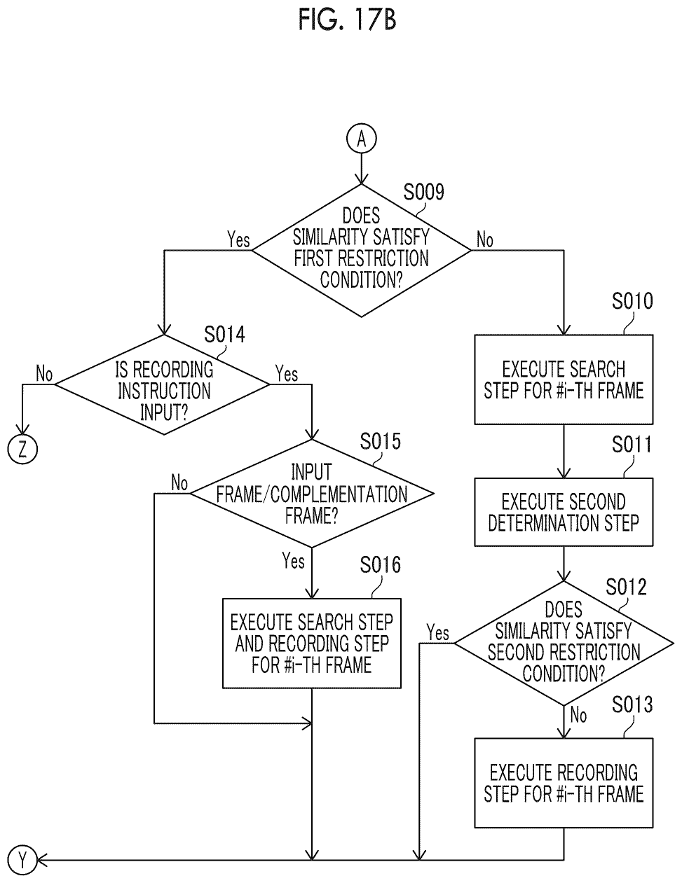

In addition, the memory 12 stores a program (hereinafter, a recording program) for recording the accessory information in the frame of the moving image data. The recording program is a program that causes the computer to execute cach step (specifically, each step in a recording flow illustrated in FIG. 17A and FIG. 17B) included in the recording method according to the embodiment of the present invention. The recording program may be acquired by being read from a computer-readable recording medium, or may be acquired by being downloaded through a communication network such as the Internet or an intranet.

In addition, the recording device 10 can freely access various kinds of data stored in a storage 15. The data stored in the storage 15 includes data required in a case where the recording device 10 records the accessory information, specifically, data of the search item described above.
Note that the storage 15 may be built in the recording device 10 or may be externally attached to the recording device 10, or may be configured with a network attached storage (NAS) or the like. Alternatively, the storage 15 may be an external device that can communicate with the recording device 10 through the Internet or a mobile communication network, such as an online storage.

The recording device 10 is configured with, for example, a moving image capturing device. The configuration (particularly, the mechanical configuration) of the image capturing device constituting the recording device 10 is substantially the same as the configuration of a well-known device having a function of capturing a moving image. In addition, the image capturing device may have an autofocus (AF) function of automatically focusing on a predetermined position within an angle of view. Further, the image capturing device may have a function of specifying a focusing position, that is, an AF point during recording of the moving image data by using the AF function.

In addition, the image capturing device has a function of detecting a shake of an angle of view that is caused by hand shaking or the like and a shake of a subject that is caused by a movement of the subject. Here, the “shake” is an irregular and slow vibration (shaking), and is different from, for example, an intentional change in angle of view, specifically, an operation of quickly changing a direction of the image capturing device along a predetermined direction (specifically, a pan operation). Note that the shake of the subject can be detected by, for example, a known image analysis technique. The shake of the angle of view can be detected by, for example, a known shake detection device such as a gyro sensor.

In addition, the image capturing device may further comprise a finder, specifically, an electronic view finder or an optical view finder, through which a user (that is, a person who captures a moving image) looks at the subject during the recording of the moving image data. In this case, the image capturing device may have a function of detecting a position of a visual line and a position of a pupil of the user during recording of the moving image data and specifying the position of the visual line of the user. The position of the visual line of the user corresponds to an intersection position between the visual line of the user who looks at the subject through the finder and a display screen (not illustrated) in the finder.

In addition, the image capturing device may be provided with a known distance sensor such as an infrared sensor. In this case, the image capturing device can measure a distance (depth) in the depth direction for each subject within the angle of view.

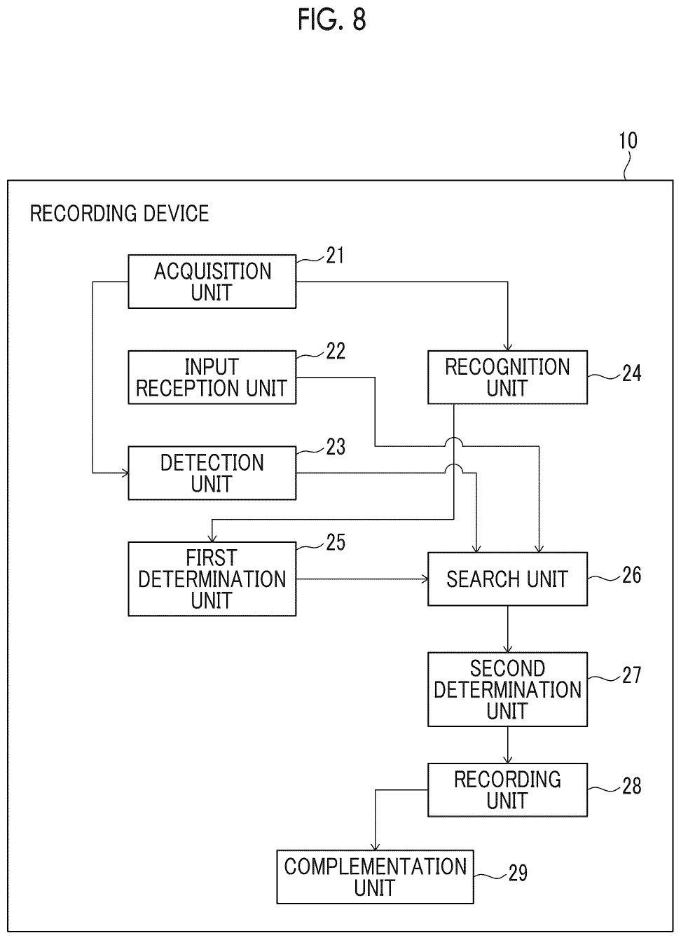

The function of the recording device 10, particularly, the function related to recording of the accessory information in the frame will be described with reference to FIG. 8. As illustrated in FIG. 8, the recording device 10 includes an acquisition unit 21, an input reception unit 22, a detection unit 23, a recognition unit 24, a first determination unit 25, a search unit 26, a second determination unit 27, a recording unit 28, and a complementation unit 29. These functional units are implemented by cooperation between the hardware device (the processor 11, the memory 12, the input device 13, and the output device 14) provided in the recording device 10 and the software including the recording program.
Hereinafter, each of the functional units will be described.

### Acquisition Unit

The acquisition unit 21 acquires the moving image data including the plurality of frames. Specifically, the acquisition unit 21 acquires the moving image data by recording a frame (frame image) at a constant frame rate within an angle of view of the image capturing device constituting the recording device 10.

### Input Reception Unit

The input reception unit 22 executes a receiving step, and receives, in the receiving step, a user operation performed in association with recording of the accessory information in the frame. The user operation received by the input reception unit 22 includes an input of the user that is related to a recording instruction of the accessory information (hereinafter, referred to as an input of a recording instruction). The input of the recording instruction is an input operation performed to instruct a target frame in which the accessory information is to be recorded, among the plurality of frames included in the moving image data. Specifically, during the recording of the moving image data, the user performs a predetermined operation (for example, an operation of pressing a predetermined button or an operation of uttering voice) at a timing when the user desires to record the accessory information. The input reception unit 22 receives the operation as an input of a recording instruction.

### Detection Unit

The detection unit 23 detects an occurred shake by a well-known shake detection unit in a case where a shake of the subject or the angle of view occurs during recording of the moving image data. In addition, in a case where a shake is detected, the detection unit 23 specifies a frame in which the shake is detected in the moving image data.

### Recognition Unit

The recognition unit 24 executes a recognition step, and in the recognition step, recognizes the subject in the frame of the moving image data for each frame. Specifically, in the recognition step, the subject region in the angle of view of each frame is extracted, and the subject in the extracted subject region is specified. In addition, in a case where a plurality of subjects are present in the frame (that is, in a case where a plurality of subject regions are extracted within the angle of view of the frame), the recognition unit 24 recognizes the plurality of subjects.
Note that, a form in which the subject in the frame is recognized for each frame may include a form in which there is a frame in which the subject in the frame is not recognized among the plurality of frames included in the moving image data.

### First Determination Unit

The first determination unit 25 executes a first determination step, and determines a similarity between a first frame and a second frame in the moving image data. The first frame and the second frame are frames different from each other among the plurality of frames included in the moving image data. The second frame is a frame before the first frame or a frame after the first frame.
In the following description, a case where, during the recording of the moving image data, a frame corresponding to the current time (real time) is the first frame and a frame in the past (for example, a frame several frames before the first frame) is the second frame will be described as an example.

In the first determination step, a similarity between the recognition result for the subject in the first frame and the recognition result for the subject in the second frame is determined. That is, the first determination unit 25 determines a similarity between the subject in the first frame and the subject in the second frame, the subject being recognized by the recognition unit 24.

Note that, in a case of determining the similarity, a well-known technique for evaluating (calculating) the similarity can be used. For example, each of the feature amounts of the two subjects to be compared (strictly speaking, the feature amounts of the subject regions in the angle of view of the frame) is defined in the feature amount space. In addition, the similarity between the subjects may be determined by the distance between the feature amounts in the feature amount space. In this case, as the distance is shorter, the subjects are more similar to each other (the similarity is higher).

Further, the first determination unit 25 determines, in the first determination step, whether or not the similarity satisfies a first restriction condition. The first restriction condition is a preset condition related to an execution of a search step by the search unit 26. Here, the “preset” means that the setting is performed before the search step is executed. In addition, in the embodiment of the present invention, the first restriction condition is a condition that the similarity exceeds a predetermined level. The predetermined level defines a similarity at which it can be determined that the two subjects to be compared are similar to each other.
Note that the first restriction condition is not limited to the above-described condition, and may be, for example, a condition that a state in which the similarity exceeds a predetermined level continues for several frames or more.

In addition, in a case where it is determined that the similarity exceeds the predetermined level, the first determination unit 25 determines that the similarity satisfies the first restriction condition, that is, the first frame and the second frame are similar to each other.

In addition, in a case where the recognition unit 24 recognizes a plurality of subjects in the first frame and the second frame, the first determination unit 25 sets priorities for the plurality of subjects. In this case, among the plurality of subjects, a higher priority is set for a main subject, for example, a subject closer to the center of the angle of view or a subject closer to the AF point. Alternatively, the user may designate the priority for each subject.
Note that a form in which the priority is set for each subject may include a form in which there is a subject for which the priority is not set among the plurality of subjects.

In addition, the first determination unit 25 determines the similarity based on the priorities of the plurality of subjects, and more specifically, prioritizes the similarity determined for the subject having a higher priority. For example, in a case where the similarity determined for the subject having the highest priority (that is, the main subject) exceeds the predetermined level, the first determination unit 25 may determine that the first frame and the second frame are similar to each other.
Note that a form in which the similarity is determined based on the priority of each subject may include a form in which there is a priority that is not referred to in a case of determining the similarity among the priorities of the plurality of subjects.

### Search Unit

The search unit 26 executes a search step for the target frame. In the search step, the search unit 26 searches for the accessory information that can be recorded for the subject in the target frame recognized by the recognition unit 24 among the accessory information included in the search item.

In addition, in the embodiment of the present invention, in a case where the number of target frames for which the search step is executed by the search unit 26 is set to a second number N2, the second number N2 is smaller than the first number N1. That is, the execution of the search step is restricted for a frame other than the target frame (hereinafter, referred to as a non-target frame) among the plurality of frames included in the moving image data.

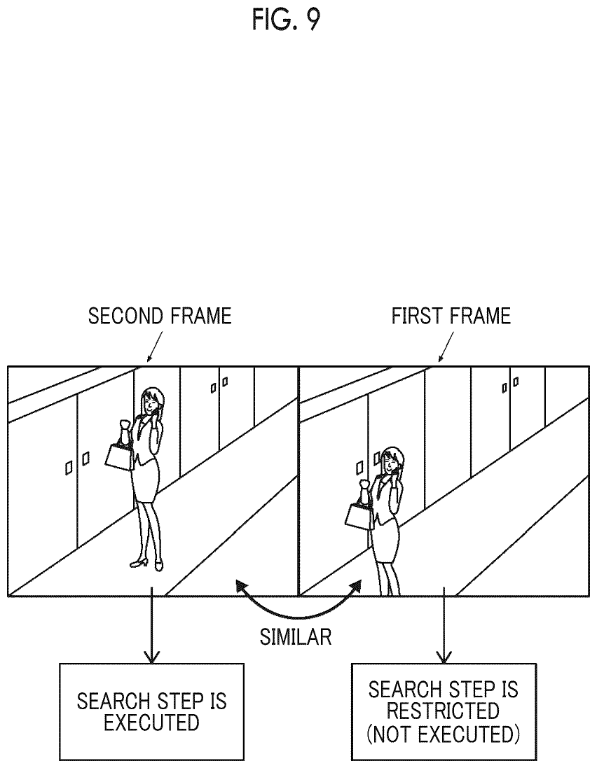

Here, restriction of the execution of the search step for the non-target frame is, for example, not to execute the search step for the non-target frame. Specifically, it is assumed that the similarity determined in the first determination step by the first determination unit 25 satisfies the first restriction condition. That is, as illustrated in FIG. 9, it is assumed that the first frame and the second frame are similar to each other. In this case, the search unit 26 sets the first frame as the non-target frame, and restricts the execution of the search step for the non-target frame. Specifically, as illustrated in FIG. 9, the search step for the first frame is omitted without being executed.

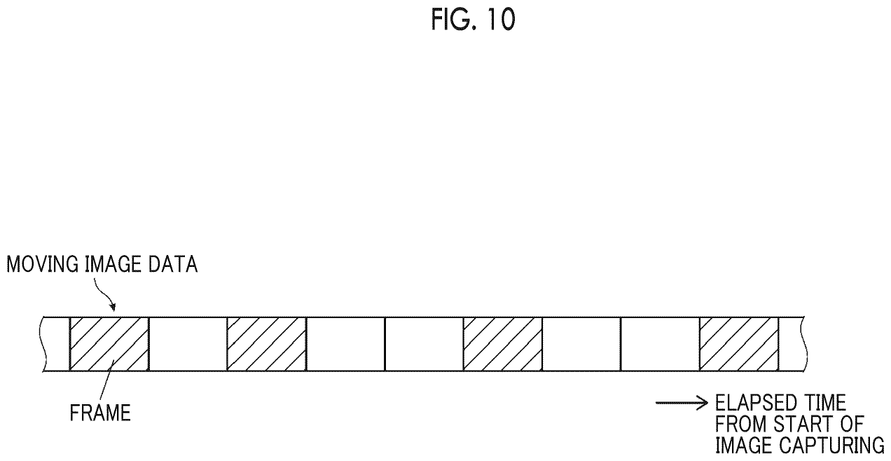

Further, since the search step is not executed for the first frame, the number of frames (target frames) in which the search step is executed, that is, the second number N2 is smaller than the first number N1. Thereby, in a case where a situation at which the preceding and subsequent frames are similar to each other continues, as illustrated in FIG. 10, an execution rate of the search step is lower than the frame rate when recording the moving image data.

Specifically, for example, in a case where the same subject is captured in the same scene and the moving image data is recorded, a state where the similarity of the subject between the preceding and subsequent frames exceeds the predetermined level continues. In this case, as illustrated in FIG. 10, an interval between the frames in which the search step is executed is longer than a recording interval of the frames in the moving image data.
Note that, in FIG. 10 to FIG. 16 and FIG. 18 and FIG. 19, among the plurality of frames included in the moving image data, the target frame in which the search step is executed is hatched with oblique lines.

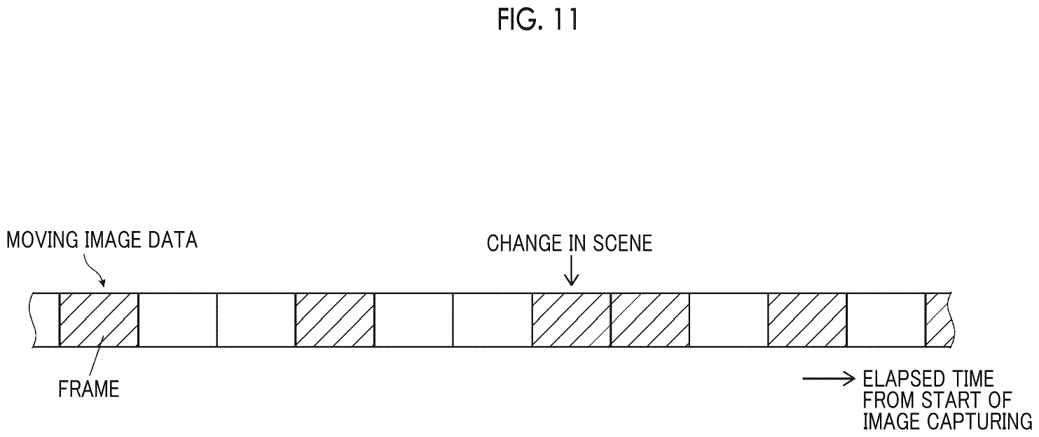

In addition, during the recording of the moving image data, it is assumed that the preceding and subsequent frames are switched due to a change or the like in the imaging scene and the similarity between the subject in the first frame and the subject in the second frame is greatly changed. In this case, the search unit 26 executes the search step for the first frame, and as illustrated in FIG. 11, increases the execution rate of the search step after the change in the scene as compared with the previous rate.

In addition, whether or not the search unit 26 executes the search step, in other words, whether the frame corresponds to the target frame or the non-target frame, may depend on a factor other than the factor. Specifically, in the moving image data, the frame in which the shake of the subject or the angle of view is detected by the detection unit 23 is a non-target frame, and the search step is not executed for the frame. Since there is a possibility that the subject is not clear in the frame in which the shake is detected, by excluding such a frame from the target of the search step, it is possible to reduce a load in the execution of the search step while ensuring the validity of the search result.

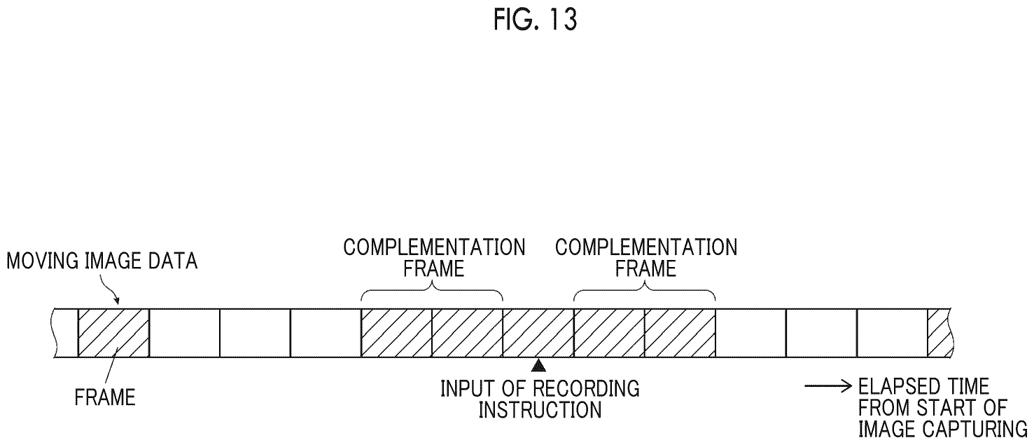

In addition, in a case where the input reception unit 22 receives an input of the recording instruction during the recording of the moving image data, the search unit 26 executes the search step for an input frame and a complementation frame as illustrated in FIG. 13. The input frame is a frame corresponding to input of a recording instruction in the moving image data, and is specifically a frame recorded at a moment when the input is received. As illustrated in FIG. 13, the complementation frame is a frame before or after the input frame, and is, for example, several frames immediately before and after the input frame. Note that the complementation frame may be only a frame before the input frame or may be only a frame after the input frame.

### Complementation Unit

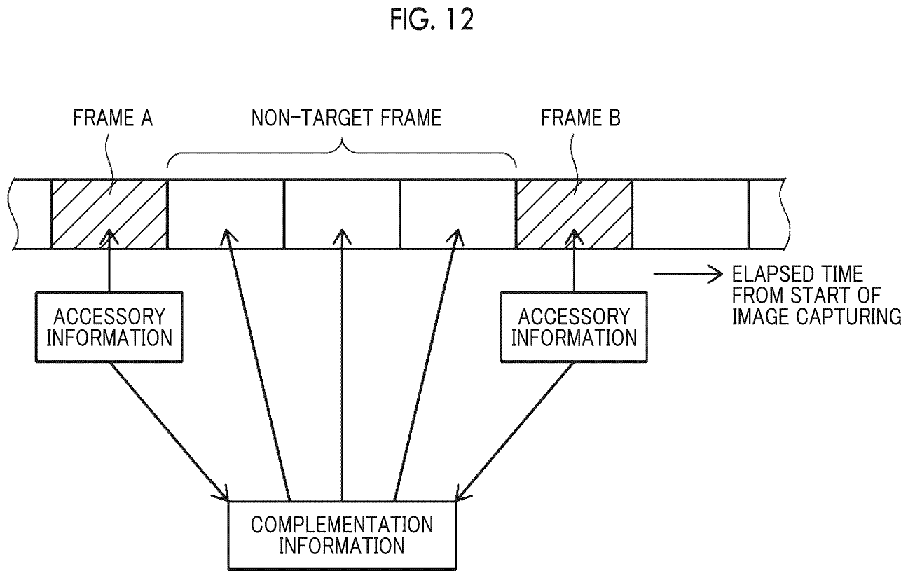

The complementation unit 29 executes a complementation step of recording complementation information in the non-target frame. The complementation information is information that is determined based on the accessory information recorded in the recording step for two frames before and after the non-target frame. Specifically, with reference to FIG. 12, for example, it is assumed that the recording step is executed to record the accessory information in each of the frame A and the frame B and that a non-target frame is present between the frame A and the frame B. Here, in a case where the accessory information recorded in the frame A and the accessory information recorded in the frame B are relatively similar, the complementation unit 29 creates complementation information (specifically, for example, an item common to the frame A and the frame B) corresponding to the information.

In addition, the complementation unit 29 executes a complementation step of recording the created complementation information in the non-target frame between the frame A and the frame B. By recording the complementation information in the non-target frame in this way, the complementation information as the accessory information can be easily recorded in the non-target frame in which the original accessory information is not recorded.
Note that, in a case where the complementation information is recorded in the non-target frame, information indicating that the complementation information is recorded may be further recorded in the non-target frame as the accessory information.

### Second Determination Unit

The second determination unit 27 executes a second determination step, and determines a similarity between a result of the search step executed for the first frame and a result of the search step executed for the second frame. Specifically, the second determination unit 27 determines a similarity between the item searched for as the accessory information that can be recorded for the subject in the first frame and the item searched for as the accessory information that can be recorded for the subject in the second frame.

Note that, in a case of determining the similarity, a well-known technique for evaluating (calculating) the similarity can be used. For example, each of the two pieces of the accessory information (items) to be compared is digitized (specifically, vectorized) by a well-known method such as Word2vec, and the digitized information is defined in the vector space. In addition, the similarity between the pieces of the accessory information may be determined by a distance between the pieces of the accessory information in the vector space. In this case, as the distance between the vectors is shorter, the pieces of the accessory information are more similar to each other.

Further, the second determination unit 27 determines, in the second determination step, whether or not the similarity satisfies a second restriction condition. The second restriction condition is a preset condition related to the execution of the recording step by the recording unit 28. Here, the “preset” means that the setting is performed before the recording step is executed. In addition, in the embodiment of the present invention, the second restriction condition is a condition that the similarity exceeds a predetermined level. The predetermined level defines a similarity at which it can be determined that two pieces of the accessory information to be compared are similar to each other.
Note that the second restriction condition is not limited to the condition and may be, for example, a condition that a state where the similarity exceeds a predetermined level continues for several frames or more.

In addition, in a case where it is determined that the similarity exceeds the predetermined level, the second determination unit 27 determines that a result of the search step executed for the first frame and a result of the search step executed for the second frame are similar to each other.

In addition, in the search step for the first frame and the second frame, in a case where the accessory information that can be recorded is searched for the plurality of subjects, the second determination unit 27 sets priorities for the plurality of subjects. In this case, among the plurality of subjects, a higher priority is set for a main subject, for example, a subject closer to the center of the angle of view or a subject closer to the AF point. In addition, the user may set the priority for each subject.
Note that a form in which the priorities are set for the plurality of subjects may include a form in which there is a subject for which the priority is not set among the plurality of subjects.

In addition, the second determination unit 27 determines the similarity based on the priorities of the plurality of subjects, and more specifically, prioritizes the similarity determined for the subject having a higher priority. For example, in a case where the similarity determined for the subject having the highest priority (that is, the main subject) exceeds the predetermined level, the second determination unit 27 may determine that the search result for the first frame and the search result for the second frame are similar to each other.
Note that a form in which the similarity is determined based on the priorities of the plurality of subjects may include a form in which there is a priority that is not referred to in a case of determining the similarity among the priorities of the plurality of subjects.

### Recording Unit

The recording unit 28 executes a recording step for the target frame. In the recording step, the recording unit 28 records the accessory information in the target frame based on a result (search result) of the search step performed by the search unit 26. More specifically, in the recording step, an item searched for from the search items, that is, an item corresponding to the subject in the target frame is recorded in the target frame as the accessory information.

In addition, in the embodiment of the present invention, in a case where the number of target frames in which the accessory information is recorded in the recording step by the recording unit 28 is set as a third number N3, the third number N3 is smaller than the first number N1 and the second number N2. That is, in the target frames, the execution of the recording step is restricted for a specific target frame (hereinafter, referred to as a non-recording frame).

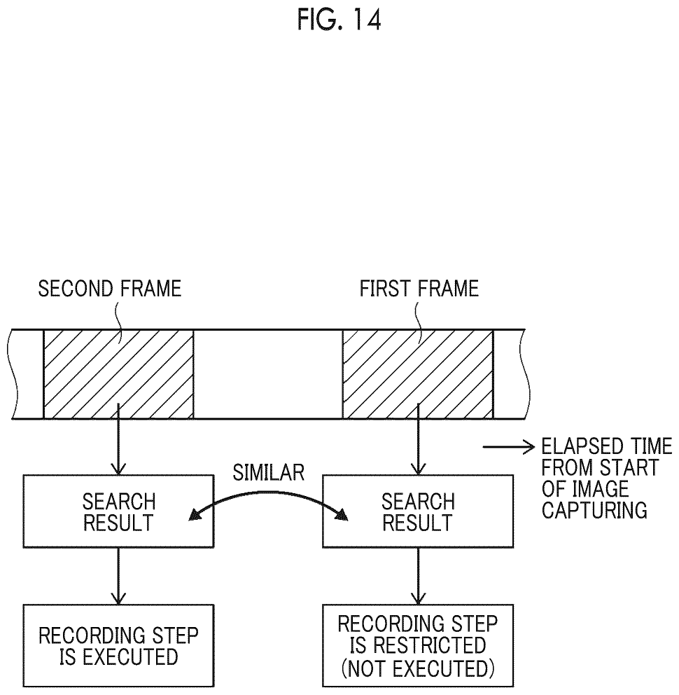

Here, the restriction of the execution of the recording step for the non-recording frame is, for example, not executing the recording step for the non-recording frame. Specifically, it is assumed that the similarity determined in the second determination step by the second determination unit 27 satisfies the second restriction condition. That is, as illustrated in FIG. 14, a scene in which the search result for the first frame and the search result for the second frame are similar to each other is assumed. In this case, the recording unit 28 sets the first frame as a non-recording frame, and restricts the execution of the recording step for the frame. Specifically, as illustrated in FIG. 14, the recording step for the first frame is omitted without being executed.

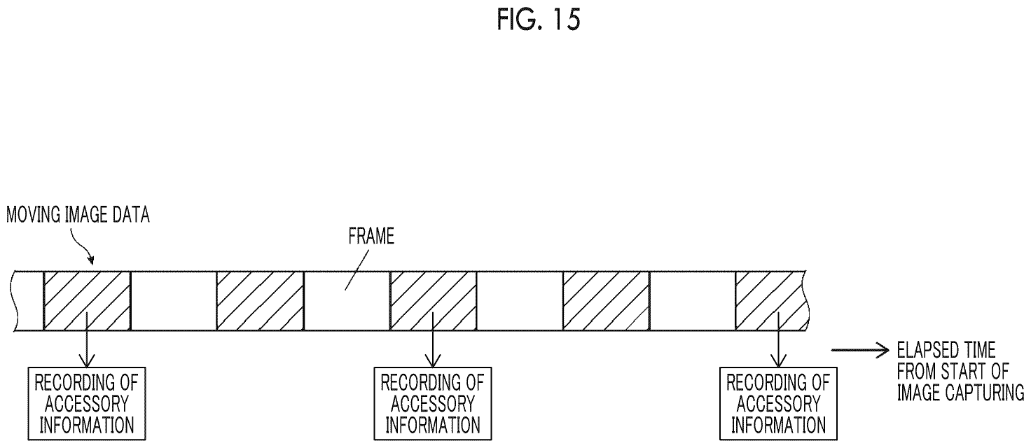

In addition, since the recording step is not executed for the first frame, the number of frames in which the recording step is executed, that is, the third number N3 is smaller than the second number N2 of the frames (target frame) in which the search step is executed. Thereby, in a case where a situation at which the results (search results) in the search steps between the preceding and subsequent frames are similar to each other continues, as illustrated in FIG. 15, an execution rate of the recording step is lower than an execution rate of the search step. That is, an interval (execution rate) between the frames in which the recording step is executed is longer than an interval between the frames (target frames) in which the search step is executed.

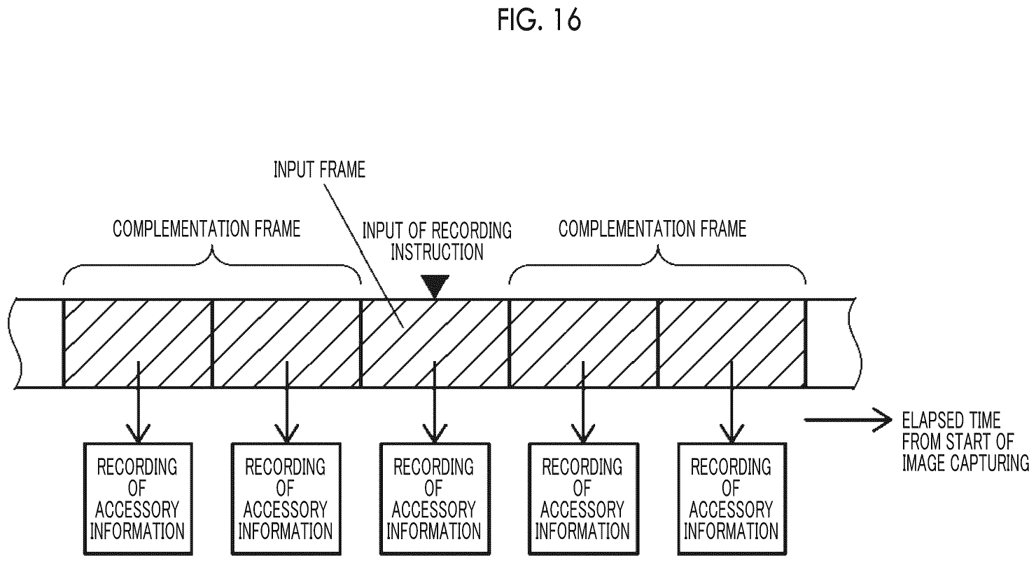

Whether or not the recording unit 28 executes the recording step, in other words, whether or not the frame corresponds to the non-recording frame may depend on a factor other than the factor. Specifically, in a case where the input reception unit 22 receives an input of a recording instruction during the recording of the moving image data, the recording unit 28 executes the recording step for the input frame and the complementation frame as illustrated in FIG. 16. That is, the recording unit 28 records the accessory information that can be recorded for the subject in the input frame based on the result of the search step for the input frame. In addition, the recording unit 28 records the accessory information that can be recorded for the subject in the complementation frame based on the result of the search step for the complementation frame.

### Recording Flow According to Embodiment of Present Invention

Next, a recording flow using the recording device 10 will be described. In a recording flow to be described below, the recording method according to the embodiment of the present invention is used. That is, each step in the recording flow to be described below corresponds to a component of the recording method according to the embodiment of the present invention.
Note that the following flow is merely an example, and within a range not departing from the gist of the present invention, some steps in the flow may be deleted, new steps may be added to the flow, or the execution order of two steps in the flow may be exchanged.

The recording flow by the recording device 10 proceeds according to the flows illustrated in FIG. 17A and FIG. 17B, and each step in the recording flow is executed by the processor 11 provided in the recording device 10. That is, in each step in the recording flow, the processor 11 executes processing corresponding to each step in data processing defined in the recording program. Specifically, the processor 11 executes recognition processing in the recognition step, executes search processing in the search step, and executes recording processing in the recording step.

The recording flow is executed by being triggered by a start of the recording of the moving image data (S001). In a case where the recording flow is started, first, i is set to 1 for a frame number #i (i is a natural number) of a frame included in the moving image data, and then the recognition step, the search step, and the recording step are executed for the #i-th frame (S002, S003). That is, the accessory information is recorded in the first frame.

In the recognition step, the subject in the frame is recognized, and in a case where a plurality of subjects are present in the frame, the plurality of subjects are recognized. In the search step, the accessory information (specifically, an item) that can be recorded for the recognized subject is searched for from the search items. In the recording step, the accessory information is recorded in the frame based on the result (search result) of the search step.

Note that, in the recording flow, the search step is not limited to being executed after the recognition step and may be executed at the same timing as the recognition step.
Note that, in a case where a shake of the subject or the angle of view is detected in the #i-th frame, step S003 is omitted.

Next, it is determined whether or not to end the recording of the moving image data (S004), and in a case where the recording is not ended, i is incremented (S005), and the process proceeds to step S006. In step S006, it is determined whether i of the frame number #i at the current time is larger than N. Here, N is a natural number of 2 or more, and may be set to any value. In a case where i is larger than N, the process proceeds to step S007. On the other hand, in a case where i is equal to or smaller than N, the process returns to step S003, and the recognition step, the search step, and the recording step are executed again for the #i-th frame.

In step S007, the recognition step is executed for the #i-th frame in the same manner as in step S003. Thereafter, the #i-th frame is set as the first frame, and a frame before the #i-th frame is set as the second frame. Then, the first determination step is executed (S008). In the first determination step, a similarity between the result of the recognition step executed for the first frame and the result of the recognition step executed for the second frame is determined. That is, in step S008, the similarity between the subject in the first frame and the subject in the second frame is determined.

Note that, in the recognition step for the first frame and the second frame, a plurality of subjects may be recognized. In this case, in the first determination step, the priorities are set for the plurality of recognized subjects, and the similarity is determined based on the priorities of the plurality of subjects. By considering the priorities of the plurality of subjects in this way, the similarity can be more appropriately determined, and for example, the similarity can be determined by giving a higher priority to the main subject among the plurality of subjects.

In addition, in the first determination step, it is determined whether or not the similarity satisfies the first restriction condition (S009). In a case where the similarity satisfies the first restriction condition, the execution of the search step for the #i-th frame (the first frame) is restricted unless a recording instruction is input. Specifically, the search step is not executed for the #i-th frame.

On the other hand, in a case where the similarity does not satisfy the first restriction condition (specifically, in a case where the similarity does not reach the predetermined level), the search step is executed for the #i-th frame in the same manner as in step S003 (S010).
Note that, in a case where a shake of the subject or the angle of view is detected in the #i-th frame, step S010 and subsequent steps are omitted.
In addition, in a case where the search step is executed in step S010, the execution rate of the search step immediately after the execution may be returned to a normal rate (initial rate).

After step S010 is executed, the #i-th frame is set as the first frame, and a frame before the #i-th frame (strictly speaking, a frame in which the search step is executed before the #i-th frame) is set as the second frame. Then, the second determination step is executed (S011). In the second determination step, a similarity between the result of the search step executed for the first frame and the result of the search step executed for the second frame is determined.

Note that, in the search step for each of the first frame and the second frame, the accessory information that can be recorded may be searched for a plurality of subjects. In this case, in the second determination step, the priorities are set for the plurality of subjects, and the similarity is determined based on the priorities of the plurality of subjects. By considering the priorities of the plurality of subjects in this way, the similarity can be more appropriately determined, and for example, the similarity can be determined by giving a higher priority to the main subject among the plurality of subjects.

In addition, in the second determination step, it is determined whether or not the similarity satisfies the second restriction condition (S012). In a case where the similarity does not satisfy the second restriction condition (specifically, in a case where the similarity does not reach the predetermined level), the recording step is executed for the #i-th frame (S013). In this step SO13, the item searched for in step S010 is recorded in the #i-th frame as the accessory information.

On the other hand, in a case where the similarity satisfies the second restriction condition, the execution of the recording step for the #i-th frame (the first frame) is restricted. Specifically, the recording step is not executed for the #i-th frame.

In addition, in the recording flow, in a case where there is an input of the user related to the recording instruction of the accessory information (S014), the processor 11 executes a receiving step of receiving the input. Thereafter, the processor 11 determines whether or not the #i-th frame corresponds to the input frame corresponding to the input of the recording instruction or the complementation frame before or after the input frame (S015).

In addition, in a case where the #i-th frame corresponds to the input frame or the complementation frame, the search step and the recording step are executed for the #i-th frame (S016).
Note that, in the recording step in a case where the #i-th frame corresponds to the input frame, information (for example, information indicating that the recording instruction is input or identification information corresponding to the information) related to the recording instruction is recorded as the accessory information. Thereby, information indicating that the user inputs the recording instruction can be recorded in the input frame as the accessory information. As a result, it is possible to specify the frame for which the user inputs the recording instruction. Further, a tendency related to the frame for which the recording instruction is input can be recognized by machine learning or the like based on the frames in which the accessory information is recorded.

A series of the steps described above, particularly, the steps subsequent to step S005 are repeatedly executed until the recording of the moving image data is ended. In addition, the recording flow is ended when the recording of the moving image data is ended.

As described above, in the recording flow according to the embodiment of the present invention, the similarity between the result of the recognition step executed for the first frame and the result of the recognition step executed for the second frame is determined. That is, the similarity between the subject in the first frame and the subject in the second frame (in other words, the similarity between the frames) is determined.

Further, in a case where the similarity satisfies the first restriction condition, that is, in a case where the first frame and the second frame are similar to each other, the execution of the search step for the first frame is restricted. Specifically, the search step is not executed for the first frame. That is, in the above case, there is a high possibility that the results of the search steps for the first frame and the second frame are similar to each other, and the search step for the first frame is restricted from the viewpoint of efficiency.

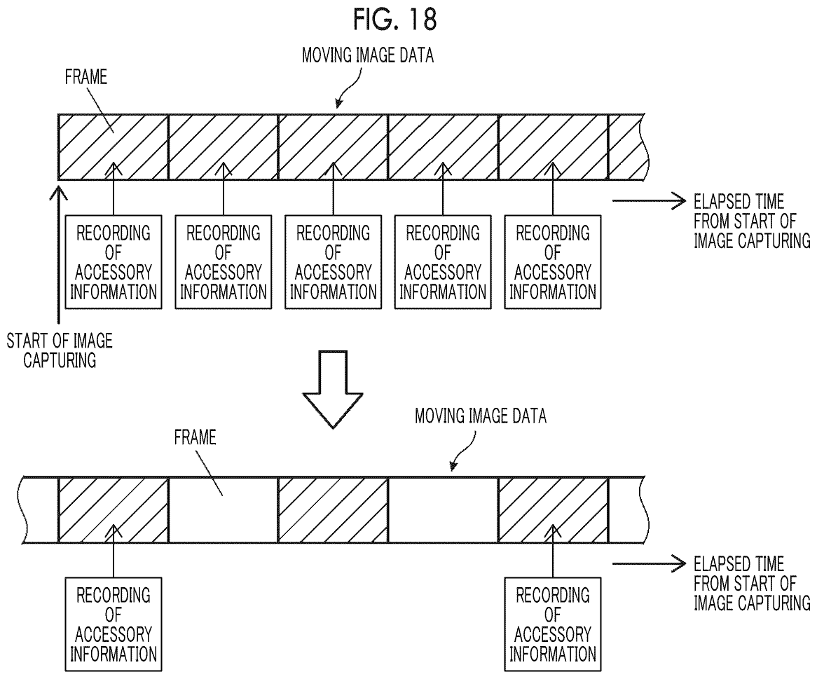

As a result, the number (the second number N2) of the frames in which the search step is executed is smaller than the number (the first number N1) of the frames included in the moving image data. That is, as illustrated in FIG. 18, the execution rate of the search step is lower than the frame rate when recording the moving image data. Thereby, it is possible to reduce a load on the execution of the search step, that is, it is possible to more efficiently execute the search step.

In addition, in the recording flow according to the embodiment of the present invention, the similarity between the result of the search step executed for the first frame and the result of the search step executed for the second frame is determined. That is, the similarity between the accessory information (item) searched for the subject in the first frame and the accessory information (item) searched for the subject in the second frame is determined.

In addition, in a case where the similarity satisfies the second restriction condition, that is, in a case where the search results of the accessory information (items) between the first frame and the second frame are similar to each other, the execution of the recording step for the first frame is restricted. Specifically, the recording step is not executed for the first frame. That is, in the above case, there is a high possibility that pieces of the accessory information recorded in the first frame and the second frame are similar to each other, and the recording step for the first frame is restricted from the viewpoint of efficiency.

As a result, the number (third number N3) of the frames in which the recording step is executed is smaller than the number (second number N2) of the frames in which the search step is executed. That is, as illustrated in FIG. 18, the execution rate of the recording step is lower than the frame rate when recording the moving image data and the execution rate of the search step. Thereby, it is possible to reduce a load on the execution of the recording step, that is, it is possible to more efficiently execute the recording step. In addition, by restricting the execution of the recording step for the first frame, the data capacity for recording the accessory information can be reduced.

In addition, in the embodiment of the present invention, the input of the user related to the recording instruction of the accessory information is received. In addition, the search step and the recording step are executed for a frame (input frame) corresponding to the input. Thereby, even in a case where the subjects in the frames are similar to each other between the input frame and the frame immediately before the input frame, the accessory information can be recorded in the input frame. Since the accessory information can be recorded in the frame (input frame) determined to reflect the intention of the user in this way, the convenience for the user in recording the accessory information is improved.

In addition, in the embodiment of the present invention, the search step and the recording step are executed for the complementation frame before or after the input frame in addition to the input frame. Thereby, the convenience for the user is further improved. That is, a shift (time lag) may occur between the original timing at which the user desires to input the recording instruction of the accessory information and the timing at which the recording instruction is actually input. Even in such a case, by executing the recording step for the complementation frame, it is possible to record the accessory information in the frame at a desired timing of the user (a timing at which the recording instruction is desired).

In the embodiment of the present invention, the complementation information is recorded in a non-target frame by using the accessory information recorded in the frames similar to each other. By recording the complementation information in the non-target frame in this way, the complementation information as the accessory information can be casily recorded in the non-target frame in which the original accessory information is not recorded.

### OTHER EMBODIMENTS

The embodiment described above is a specific example for easily understanding the recording method, the recording device, and the program according to the embodiment of the present invention, and is merely an example. Other embodiments can also be considered.

### Execution of Search Step

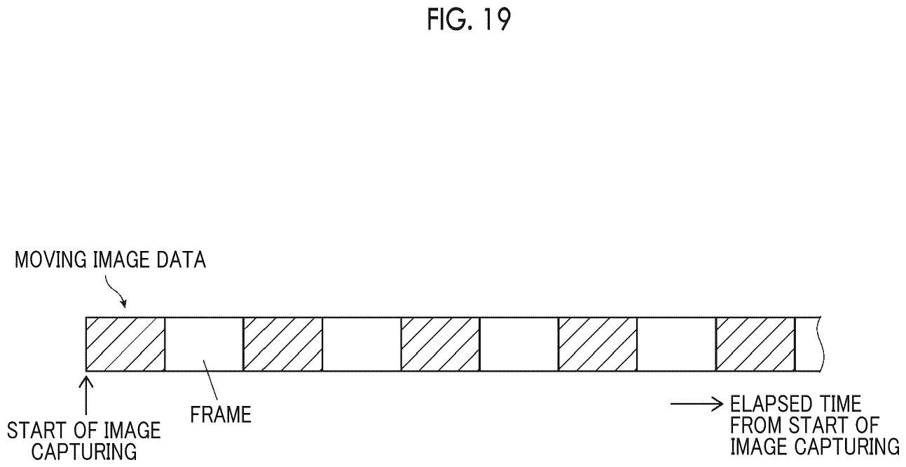

In the embodiment described above, the search step is executed for each frame at the start of the recording of the moving image data. In other words, the execution rate of the search step is set to be the same as the frame rate when recording the moving image data (refer to FIG. 18). On the other hand, the present invention is not limited thereto, and as illustrated in FIG. 19, the execution rate of the search step may be lower than the frame rate when recording the moving image data from the start of the recording of the moving image data.

### Restriction of Execution of Search Step

In the embodiment described above, as a form in which the execution of the search step is restricted, a form in which the search step is not executed has been described. On the other hand, the present invention is not limited to the above-described form. As a form in which the execution of the search step is restricted, for example, a form in which the search step for some subjects in the frame is interrupted may be adopted, or a form in which the search step is simplified by reducing the number of items in the search items may be adopted. In addition, reusing the search result for the frame in which the search step is previously executed can also be one aspect in which the execution of the search step is restricted. In addition, the accessory information indicating the reuse of the search result may be recorded in the frame in which the past search result is reused.

### Restriction of Execution of Recording Step

In the embodiment described above, as a form in which the execution of the recording step is restricted, a form in which the recording step is not executed has been described. On the other hand, the present invention is not limited to the above-described form. As a form in which the execution of the recording step is restricted, for example, a form in which the recording of a part of the searched accessory information is interrupted may be adopted, or a form in which the number of pieces of the accessory information (specifically, the number of items) to be recorded is reduced may be adopted.

### Determination of Similarity Between Frames

In the embodiment described above, the similarity between the first frame and the second frame is determined based on the subject in each frame. On the other hand, in this case, the content other than the subject may be considered. Specifically, the similarity between the frames may be determined in consideration of the direction of the image capturing device, the movement of the subject, the voice emitted by the subject, and the like at each timing during the recording of the moving image data. In addition, based on the content, in a case where it is determined that the first frame and the second frame are different from each other, the execution rate of the search step may be set to be higher than the previous rate.

### Device/Equipment Included in Recording Device According to Present Invention

In the embodiment described above, the recording device according to the embodiment of the present invention is configured with a moving image capturing device (that is, a device that records the moving image data). On the other hand, the present invention is not limited thereto. The recording device according to the embodiment of the present invention may be configured with a device other than the image capturing device, for example, an editing device that acquires moving image data obtained by capturing a moving image from the image capturing device and performs data editing.

### Execution Time of Recognition Step, Search Step, and Recording Step

In the embodiment described above, the recognition step, the search step, and the recording step are executed for the frame in the moving image data while recording the moving image data. In this case, the past frame is set as the second frame, the frame (for example, the frame at the current time) after the second frame is set as the first frame, and the similarity between the first frame and the second frame is determined. In addition, in a case where the similarity satisfies the first restriction condition or the second restriction condition, the execution of the search step or the recording step for the first frame is restricted.
On the other hand, the present invention is not limited thereto. After the recording of the moving image data is ended, the recognition step, the search step, and the recording step may be executed for the frame in the moving image data. In this case, the recognition step, the search step, and the recording step may be executed in order from the final frame in the moving image data. In other words, the first frame may be set to a frame before the second frame, the similarity between the frames may be determined, and whether or not the similarity satisfies each restriction condition may be determined.

### Modification Example of Data for Which Accessory Information is Stored

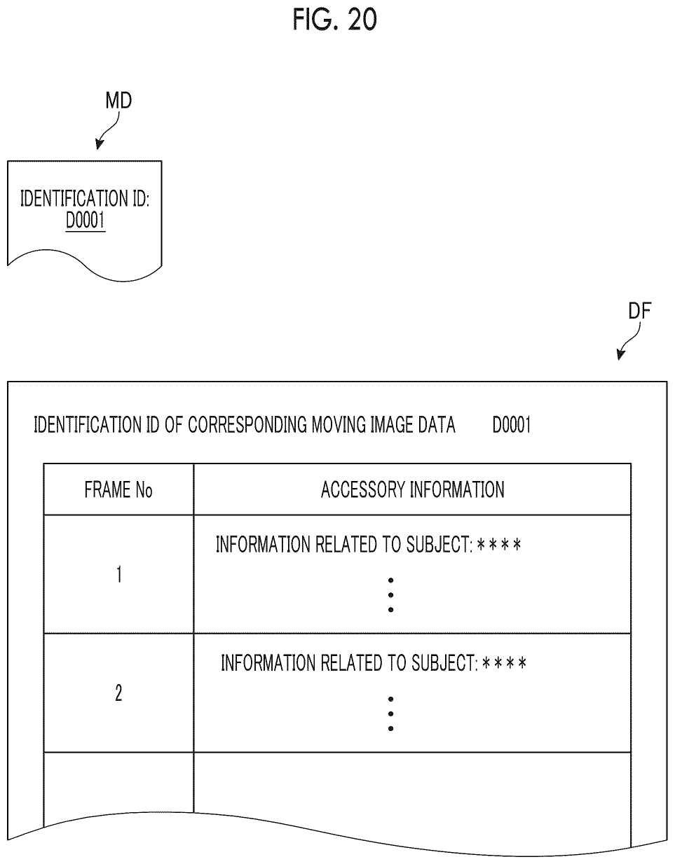

In the embodiment described above, the accessory information for the frame is stored in a part of the moving image data (specifically, a box region in a data structure of the frame). On the other hand, the present invention is not limited thereto. As illustrated in FIG. 20, the accessory information may be stored in a data file different from the moving image data. In this case, a data file in which the accessory information is stored (hereinafter, an accessory information file DF) is associated with the moving image data MD including the frame to which the accessory information is added. Specifically, the accessory information includes an identification ID of the moving image data. In addition, as illustrated in FIG. 20, in the accessory information file DF, the number of the frame in which the accessory information is recorded and the accessory information related to the subject in the frame are stored for each frame.
By storing the accessory information in a data file different from the moving image data as described above, it is possible to appropriately record the accessory information for the frame in the moving image data while preventing an increase in capacity of the moving image data.
Note that a form in which the accessory information is recorded in the accessory information file DF for each frame may include a form in which there is a frame in which the accessory information is not described among the plurality of frames included in the moving image data.

### Configuration of Processor

The processor provided in the recording device according to the embodiment of the present invention includes various processors. Examples of the various processors include a CPU that is a general-purpose processor that executes software (program) and functions as various processing units.
Moreover, various processors include a programmable logic device (PLD), which is a processor of which a circuit configuration can be changed after manufacturing, such as a field programmable gate array (FPGA).
Furthermore, the various processors include a dedicated electric circuit that is a processor having a circuit configuration specially designed for executing a specific process, such as an application specific integrated circuit (ASIC).

In addition, one functional unit included in the recording device according to the embodiment of the present invention may be configured by one of the various processors described above. Alternatively, one functional unit included in the recording device according to the embodiment of the present invention may be configured by a combination of two or more processors of the same type or different types, for example, a combination of a plurality of FPGAs or a combination of an FPGA and a CPU.
In addition, the plurality of functional units included in the recording device according to the embodiment of the present invention may be configured by one of the various processors, or two or more of the plurality of functional units may be configured by one processor.
In addition, as in the above-described embodiment, one processor may be configured of a combination of one or more CPUs and software, and the processor may function as the plurality of functional units.

In addition, for example, as typified by a system on chip (SoC) or the like, a form may be adopted in which a processor that realizes the functions of the entire system including the plurality of functional units in the recording device according to the embodiment of the present invention with one integrated circuit (IC) chip is used. Moreover, a hardware configuration of the various processors described above may be an electric circuit (circuitry) in which circuit elements, such as semiconductor elements, are combined.

### EXPLANATION OF REFERENCES

10: recording device
11: processor
12: memory
13: input device
14: output device
15: storage
21: acquisition unit
22: input reception unit
23: detection unit
24: recognition unit
25: first determination unit
26: search unit
27: second determination unit
28: recording unit
29: complementation unit
DF: accessory information file
MD: moving image data

What is claimed is:

1. A recording method of recording accessory information in a frame of moving image data including a plurality of frames, the recording method comprising:
a recognition step of recognizing a subject in the frame for each of the frames;
a search step of searching for the accessory information that is able to be recorded for the recognized subject among pieces of the accessory information; and
a recording step of recording the accessory information in the frame based on a result of the search step,
wherein, in a case where the number of the frames included in the moving image data is set as a first number and the number of the frames in which the search step is executed is set as a second number, the second number is smaller than the first number, and
the search step is not executed for the frame in which a shake of a subject or an angle of view is detected.

2. The recording method according to claim 1, further comprising:
a first determination step of determining a similarity between a result of the recognition step executed for a first frame among the plurality of frames and a result of the recognition step executed for a second frame different from the first frame among the plurality of frames,
wherein, in a case where the similarity determined in the first determination step satisfies a first restriction condition related to an execution of the search step, the execution of the search step for the first frame is restricted.

3. The recording method according to claim 2,
wherein, in a case where a plurality of subjects are recognized in the recognition step for the first frame and the second frame, in the first determination step, priorities are set for the plurality of subjects, and the similarity is determined based on the priorities of the plurality of subjects.

4. The recording method according to claim 1,
wherein, in a case where the number of frames in which the accessory information is recorded in the recording step is set as a third number, the third number is smaller than the second number.

5. The recording method according to claim 4, further comprising:
a second determination step of determining a similarity between a result of the search step executed for a first frame among the plurality of frames and a result of the search step executed for a second frame different from the first frame among the plurality of frames,
wherein, in a case where the similarity determined in the second determination step satisfies a second restriction condition related to an execution of the recording step, the execution of the recording step for the first frame is restricted.

6. The recording method according to claim 5,
wherein, in the search step for the first frame and the second frame, in a case where the accessory information that is able to be recorded is searched for a plurality of subjects, in the second determination step, priorities are set to the plurality of subjects, and the similarity is determined based on the priorities of the plurality of subjects.

7. The recording method according to claim 1, further comprising:
a receiving step of receiving an input of a user that is related to a recording instruction of the accessory information,
wherein the recording step is executed to record the accessory information in an input frame corresponding to the input of the user, among the plurality of frames.

8. The recording method according to claim 7,
wherein, in the recording step for the input frame, information related to the recording instruction is recorded as the accessory information.

9. The recording method according to claim 8,
wherein the recording step is executed to record the accessory information in the input frame and a complementation frame before or after the input frame, among the plurality of frames.

10. The recording method according to claim 1,
wherein the accessory information is stored in a data file different from the moving image data.

11. A recording device that records accessory information in a frame of moving image data including a plurality of frames, the recording device comprising:
a processor,
wherein the processor is configured to execute:
recognition processing of recognizing a subject in the frame for each of the frames;
search processing of searching for the accessory information that is able to be recorded for the recognized subject among pieces of the accessory information; and
recording processing of recording the accessory information in the frame based on a result of the search processing,
wherein, in a case where the number of the frames included in the moving image data is set as a first number and the number of the frames in which the search processing is executed is set as a second number, the second number is smaller than the first number.

12. A program causing a computer to execute each of the recognition step, the search step, and the recording step included in the recording method according to claim 1.
